(19) United States
(12) Patent Application Publication
(10) Pub. No.: US 2007/0156268 A1
(43) Pub. Date: Jul. 5, 2007

(54) PROVIDING AUDIOGRAPHS THROUGH A WEB SERVICE

(76) Inventors: Brian M. Galvin, Warwick, RI (US); Marshall S. Votta, Greenville, RI (US)

Correspondence Address: STRATEGIC PATENTS P.C.., C/O PORTFOLIOIP, P.O. BOX 52050, MINNEAPOLIS, MN, 55402, US

(21) Appl. No.: 11/564,169

(22) Filed: Nov. 28, 2006

Related U.S. Application Data
(60) Provisional application No. 60/740,014, filed on Nov. 28, 2005.

(51) Int. Cl. G06F 17/00

(52) U.S. Cl. 700/94

(57) ABSTRACT

Aspects of the present invention relate to improved systems and methods adapted to receive an audio recording from a celebrity, store the audio recording in a digital format, associate authentication information with the audio recording, and communicate the audio recording to an intended recipient via an Internet service.

### CROSS-REFERENCE TO RELATED APPLICATIONS

This application claims the benefit of commonly-owned U.S. Provisional Patent Application No. 60/740,014 filed on Nov. 28, 2005, the entire contents of which are incorporated herein by reference.

### FIELD OF THE INVENTION

This invention relates to methods and systems for communicating an audiograph to an intended recipient using a web service.

### BACKGROUND

People may collect items from characters, persons, celebrities, or some other notable persons that may be monetarily valuable, personally valuable, or the like. The characters, persons, celebrities, or other notable persons may come from the fields of music, film, sports, politics, or the like. Items that the characters or persons may have used, worn, handled, or implicit/explicit endorsement may gain value to such an extent that a collectible market is created in which collectors seek to trade, sell, and/or auction the items of the persons or characters. Currently, a character, person, celebrity, or other notable person may sign the item and may provide some indication of authentication that the signature is that of the character, person, celebrity, or other notable person. In many cases, the item has a signature that may enhance the value of the item. In some cases, these items have been received at an event (e.g. baseball game or music concert) and the item is associated with a personal memory of the event and the signature. In other cases, the item may have been purchased with the signature and authentication of the character, person, celebrity, or other notable person just because the receiving person likes to collect items from this character, person, celebrity, or other notable person.

However, for many collectible items sought by collectors, there is no direct contact or connection between the character, person, celebrity, or other notable person and the collector. Thus, a collectible item, such as a signature, may not be self-authenticating because it was not witnessed by the collector. The lack of authentication may also decrease the market value of the collectible item as well, in so far that the authenticity of the collectible may have no referent other than the verbal assurance of the current owner. Furthermore, the lack of contact between the collector and the character, person, celebrity, or other notable person may depersonalize the item for that collector. Whereas a collector attending a baseball card show may have the opportunity to have a star player preface his signature with the collector's name, many collectors may lack the opportunity for such face-to-face meetings and may therefore have to satisfy themselves with a non-personalized signature or other indicia of the character, person, celebrity, or other notable person.

Thus, there is a need for a method and system for providing a personalized collectible that differentiates a collectible in a manner that increases the personal value of the item, and that serves to authenticate the collectible as truly associated with a character, person, celebrity, or other notable person in order to ensure the future market value of the collectible.

### SUMMARY

In an embodiment, a recording may be made using a digital recorder, an Ipod, a Dictaphone, a portable dictation machine, a portable audio player, an Mp3 player-microphone combination, a phone line, a telephone, a mobile phone, a cellular phone, a GSM phone, a personal computer, a handheld recorder, a preexisting recording (e.g., a vintage recording, a new recording and a preexisting recording, and the like. The recording may be made using a cellular phone; the cellular phone may record an audio file for future transfer using the cellular phone.

In an embodiment, an authentication may be based at least in part on an IP address, a dedicated telecommunications connection, a password protected access, an encrypted channel, a voice spectrum analysis, a voiceprint, a digital signature, a brand, a distribution channel, a sales channel, or the like. The dedicated telecommunications connection may be a phone line, a wireless connection, or the like.

In an embodiment, the recording may be received from a digital recorder, an Ipod, a Dictaphone, a portable dictation machine, a portable audio player, an Mp3 player, a phone line, a telephone, a mobile phone, a cellular phone, a GSM phone, a personal computer, a handheld recorder, a preexisting recording, a new recording and a preexisting recording, and the like. The recording may be received from a cellular phone; the cellular phone records an audio file for future transfer using the cellular phone. The recording may be transferred using a form of high fidelity audio transfer, such as using USB as a transfer means, or some other high fidelity transfer method or system.

In an embodiment, a person or character may be an athlete. The athlete may be a professional athlete, a baseball player, a football player, a hockey player, a basketball player, a soccer player, a boxer, a golfer, a wrestler, a skier, a tennis player, a swimmer, a polo player, a driver (e.g., NASCAR, Formula One, and the like), a rugby player, a lacrosse player, a track and field athlete, a jockey, a wheelchair athlete, a former player, a current player, a retired player, a collegiate athlete, an Olympic athlete, Special Olympic athlete, an “extreme athlete,” an amateur athlete, or the like.

In an embodiment, the person or character may be an actor. The actor may be a movie actor, a theater actor, a TV actor, a voiceover actor, a commercial actor, a broadcaster, or the like.

In an embodiment, the person or character may be a musician, an artist, a political figure, a military figure, a scientist, an activist, a historical figure, a news personality, a commentator, or the like.

In an embodiment, the person or character may be a fictitious character. The fictitious character may be a movie character, a television character, a cartoon character, a theatrical character, or the like.

In an embodiment, a collectible item may be a doll, a painting, a car, a picture, a new toy, a classic toy, a stuffed toy, a teddy bear, a lunch box, a record, a sports card, a baseball card, a football card, a hockey card, a basketball card, a musical band card, a cup, a boat, a spoon, a stamp, a doll house, a scale house, a scale car, a plane, a scale plane, a vase, a musical instrument, a book, a bookmark, an action figure, a figurine, an ornament, an art print, an art painting, an art picture, a statue, a lapel pin, a magnet, a plaque, a magazine, a comic book, wine, a game, a baseball, a football, a hockey puck, a basketball, a softball, a soccer ball, furniture, or the like.

A method and system disclosed herein may include recording an audiograph of the person, character, or the like; authenticating the audiograph; and associating the audiograph with the collectible item.

A method and system disclosed herein may include recording an audiograph of the person, character, or the like; and associating the audiograph with the collectible item.

A method and system disclosed herein may include receiving the recording of an audiograph of the person, character, or the like; authenticating the audiograph; and associating the audiograph with the collectible item.

The received recording may be stored within a facility.

A method and system disclosed herein may include receiving the recording of an audiograph of the person, character, or the like; and associating the audiograph with the collectible item.

A method and system disclosed herein may include receiving the recording an audiograph of the person, character, or the like; associating the audiograph with the collectible item; and distributing the collectible item with the associated audiograph through a web service.

The web service may be a media distribution server, associated with an Mp3, a cellular phone, a personal computer, or the like.

A method and system disclosed herein may include recording a videograph of the person, character, or the like; authenticating the videograph; and associating the videograph with the collectible item.

A method and system disclosed herein may include recording an audiograph or videograph of the person, character, or the like; authenticating the audiograph or videograph; associating the audiograph or videograph with the collectible item; creating a unique, traceable identifier for the audiograph or videograph; and associating the unique, traceable identifier with the audiograph or videograph and collectible item association.

The unique, traceable identifier may be a bar code, a serial number, an image, a logo, a stamp, a unique seal, an audio message, an RFID tag, a magnetic tag, or the like.

A method and system disclosed herein may include recording an audio segment of the person, character, or the like, wherein the contents of the audio segment are personalized to a collector; and associating the collectible item with the recording personalized to the collector.

The collector may be a single person, a plurality of persons, an institution, a club, a collectibles merchant, or the like.

The collector may request a personalized audio segment from a person or character. The collector may request the personalized audio segment using a letter, a fax, an email, a text message, an instant message, a website, in person, or the like.

A method and system disclosed herein may include paring the collectible item with an audio segment; associating a serial number with pairing; listing the serial numbers of pairings in a website registry; and authenticating a pairing by verifying the serial number on the pairing against the registry.

The registry may be a third party registry used in part to assign serial numbers. The third party may be a manufacturer, a distributor, or the like.

A method and system disclosed herein may include paring the collectible item with an audio segment; creating a digital analytic profile of the audio segment and associating it with a paring; listing digital analytic profiles of pairings in a website registry; submitting the audio segment of the paring to the registry; and authenticating the paring based at least in part on the match between the audio segment and the associated digital analytic profile.

The digital analytic profile may include a measure of frequency. The frequency may be measured at multiple temporal points in the audio segment.

The digital analytic profile may include a measure of amplitude. The amplitude may be measured at multiple temporal points in the audio segment. The digital analytic profile may include a measure of time.

A method and system disclosed herein may include paring the collectible item with an audio segment; associating a mark with the pairing; and authenticating the pairing based at least in part on the presence of the mark.

The mark may be a trademark. The trademark may be a word, a motto, a logo, a graphic, a service mark, or the like.

Aspects of the present invention relate to improved systems and methods adapted to receive an audio recording from a celebrity, store the audio recording in a digital format, associate authentication information with the audio recording, and communicate the audio recording to an intended recipient via an Internet service.

In embodiments, the Internet service may involve emailing, using SMS, using VoIP, or involve communicating the audio recording through a website interaction, or some other method or system.

In embodiments, a celebrity may be a singer, an actor, a sports figure, or some other type of well-known and/or popular figure.

In embodiments, the authentication information may be stored in a tag. Authentication information may include digital rights management information to prevent the unauthorized copying of the audio recording.

In embodiments, the step of receiving the audio recording may involve receiving the audio recording through an Internet transmission. An Internet transmission may involve emailing, text messaging, using SMS, posting the audio recording to a website, or using some other form of Internet transmission.

In embodiments, the audio recording may include a personalized message from a celebrity, or other type of well-known or popular figure.

These and other systems, methods, objects, features, and advantages of the present invention will be apparent to those skilled in the art from the following detailed description of the preferred embodiment and the drawings.

### BRIEF DESCRIPTION OF FIGURES

The systems and methods described herein may be understood by reference to the following figures:

FIG. 1 shows a block diagram of the components for the audiograph and videograph creation and distribution.

FIG. 2 illustrates processes for audiograph and videograph creation, and their association with other facilities.

FIG. 3a illustrates an audiograph that is associated with a collectible.

FIG. 3b illustrates a videograph that is associated with a collectible.

FIG. 4 illustrates an audiograph that is associated with a photograph holder.

FIG. 5 illustrates an audiograph that is associated with a merchandise tag.

FIG. 6 illustrates a videograph that is associated with a portable video player.

FIG. 7 illustrates a recording that is associated with an email.

FIG. 8 illustrates a recording that is associated with a sports card.

FIG. 9 illustrates a recording that is associated with a sports item.

FIG. 10 illustrates a recording that is associated with a DVD.

FIG. 11 illustrates a recording that is associated with a toy.

FIG. 12 illustrates an audiograph that is associated with an answering machine.

FIG. 13 illustrates a recording that is associated with a ground mailing process.

FIG. 14 illustrates a recording that is associated with a greeting card.

### DETAILED DESCRIPTION

People, groups, collectors, and the like may acquire items that are considered collectibles in various ways that may include purchasing the item, trading for the item, attending an event, going to a collectible show, or the like. The collectibles may have a value depending on the rarity of the item, the character, person, celebrity, or other notable person that the item is associated with (e.g. athlete or actor), the event that the item is from (e.g. concert ticket), or the like. The collectibles may increase in value if the character or person associated with the item has signed the item, applied a marked to the item, or the like.

An aspect of this invention may be to associate audio and/or video with a collectible item in the form of an audiograph and videograph to make the collectible more personal, make the collectible more valuable, or the like. In an embodiment, the character, person, celebrity, or other notable person associated with the collectible may provide an audio and/or video file that may be associated with the collectible. Therefore, the collector may have a collectible item with a signature of the character, person, celebrity, or other notable person and may also have an audio and/or video from the character or person to associate with the collectible. In an embodiment, the combination of the collectible and audio and/or video may make the collectible more personal and/or more valuable.

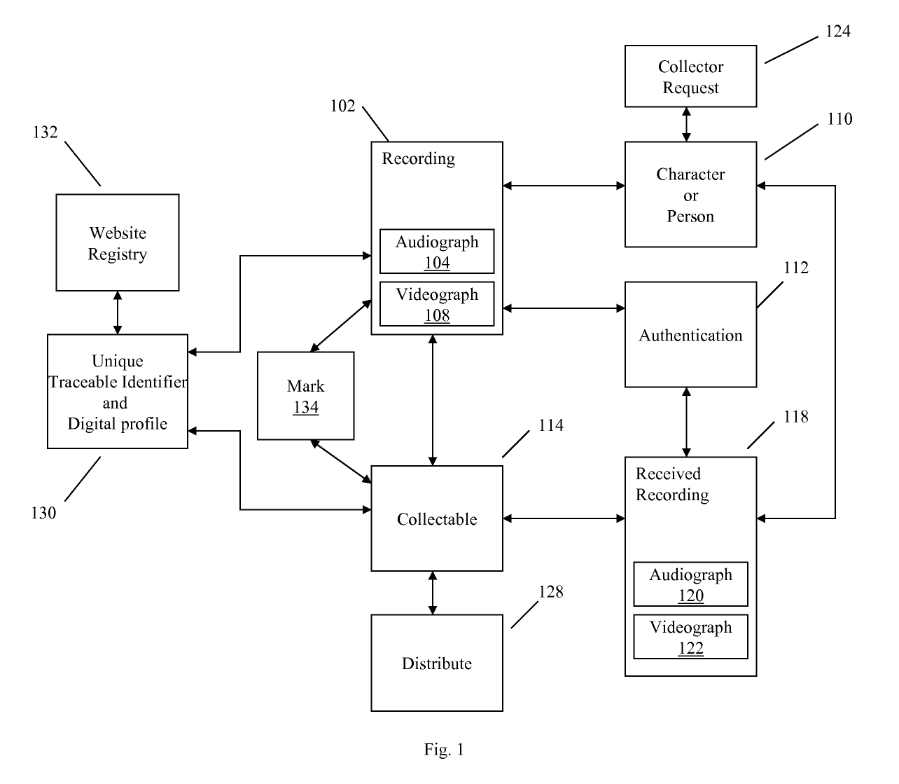

Now referring to FIG. 1, an embodiment of audiographs and videographs associated with collectibles is shown. In an embodiment, a character, person, celebrity, or other notable person 110 may make a recording 102 for the purposes of associating the recording 102 with a collectible 114 item. The impetus for the recording may arise from a collector request 124. A collector request 124 may originate from a fan of the character, person, celebrity, or other notable person 110, an entity with a commercial interest in obtaining a recording 102 of the character, person, celebrity, or other notable person 110, or originate from an individual or entity with some other relationship to the character, person, celebrity, or other notable person 110, for example. The collector request 124 may derive from an individual or entity that is the intended final recipient of the combined collectible 114 and recording 102, or the collector request 124 may derive from an individual or entity that intends to distribute the combination to some third party. In an embodiment, a character, person, celebrity, or other notable person 110 may be anyone, when associated with a collectible 114, enhances the value of the collectible 114 to an intended person. In an embodiment, a character, person, celebrity, or other notable person 110 may be associated with a collectible if the character, person, celebrity, or other notable person 110 signs the collectible 114, the collectible 114 resembles the character or person 110, the character, person, celebrity, or other notable person 110 endorses the collectible, the collectible bears some relationship to the character, person, celebrity, or other notable person 110, or the like.

The recording 102 made by a character, person, celebrity, or other notable person 110 may be an audiograph 104 or a videograph 108.

In embodiments, the character, person, celebrity, or other notable person 110 may create a received recording 118 that is received by a party other than the character, person, celebrity, or other notable person 110 who made the received recording 118.

In an embodiment, the recording 102 may be made at a recording location that may produce the collectible 114, sell the collectible 114, provide recordings 102 for the collectible, or the like. In an embodiment, the character, person, celebrity, or other notable person 110 may go to the recording location to make the recording 102 using the recording equipment that may be available at the recording location.

In an embodiment, the recording 102 may be recorded at the recording location using a digital recorder, an Ipod, a Dictaphone, a portable dictation machine, a portable audio player, an Mp3 player-microphone combination, a phone line, a telephone, a mobile phone, a cellular phone, a GSM phone, a personal computer, a handheld recorder, a preexisting recording, a new recording and a preexisting recording, and the like. The recording may be made using a cellular phone; the cellular phone may record an audio file for future transfer using the cellular phone. In another embodiment, a received recording 118 may be made at the location of the character, person, celebrity, or other notable person 110 and then sent to a location where the received recording 118 may be associated with the collectible 114.

In embodiments, a recording 102 and a received recording 118 may be associated with authentication 112. Authentication may serve to provide assurance that the recording 102 or received recording 118 was created by, with the approval of, or awareness of the character, person, celebrity, or other notable person 110 appearing on the recording 102 or received recording 118.

The recording 102 may be associated with a mark 134, such as a trademark. This association with a mark 134 may be direct (e.g., affixed directly to the recording 102), or it may be associated with the recording 102 in other packaging, advertising, promotions, or other materials related to the recording 102. In embodiments, it is the association with the mark 134 that provides indicia of authentication. For example, a trusted mark, such as MLB®, NFL®, Hallmark® or the like may be associated with the recording and/or the collectible/Audiograph to provide the collector with an indication that the audiograph is authentic.

In embodiments, the recording 102 or a received recording 118 may be associated with a collectible 114. A collectible 114 may be any item that, in the opinion of the individual or entity making the collector request 124, bears some relation or relevance to the character, person, celebrity, or other notable person 110 appearing on the recording 102.

In embodiments, a collectible 114 that is associated with a recording 102 or received recording 118, whether the recording 102 is an audiograph 104 and/or a videograph 108, may be distributed 128. The distribution may be directly to the individual or entity making the collector request 124, to an intermediary, or to some third party.

In embodiments, a recording 102, a received recording 118, a collectible 114, or a combination of a collectible 114 and a recording 102 or received recording 118 may be associated with a unique traceable identifier and digital profile 130. Examples of unique traceable identifiers and digital profiles 130 include, but are not limited to, a serial number, a digital audio profile, frequency signature, or some other unique identifier. A website registry 132 may be associated with the unique traceable identifiers and digital profiles 130. This website registry 132 may be used to store the unique traceable identifiers and digital profiles 130, and it may also serve as an interactive facility with which interested parties may obtain data, such as the existence of a recording 102 by a particular character, person, celebrity, or other notable person 110, the authenticity of a recording 102, the match of a unique identifier 130 in the website registry 132 with that appearing on a collectible 114, and the like.

In embodiments, a character, person, celebrity, or other notable person 110 may be an athlete. The athlete may be a professional athlete, a baseball player, a football player, a hockey player, a basketball player, a soccer player, a boxer, a golfer, a wrestler, a skier, a tennis player, a swimmer, a polo player, a driver (e.g., NASCAR, Formula One, and the like), a rugby player, a lacrosse player, a track and field athlete, a jockey, a wheelchair athlete, a former player, a current player, a retired player, a collegiate athlete, an Olympic athlete, Special Olympic athlete, an “extreme athlete,” an amateur athlete, or the like. A person or character may be an actor. The actor may be a movie actor, a theater actor, a TV actor, a voiceover actor, a commercial actor, a broadcaster, or the like. A person or character may be a musician, an artist, a political figure, a military figure, a scientist, an activist, a historical figure, a news personality, a commentator, or the like. A person or character may be a fictitious character. The fictitious character may be a movie character, a television character, a cartoon character, a theatrical character, or the like. A person or character may be another notable person. While embodiments of the present invention describe people and characters of note, fame, celebrity, personality and the like, it should be understood that these terms are interchangeable within the context of the present invention and are intended to capture a person, character, group and the like for which an audio recording and/or video recording may be sought as a collectible or for the association with a collectible.

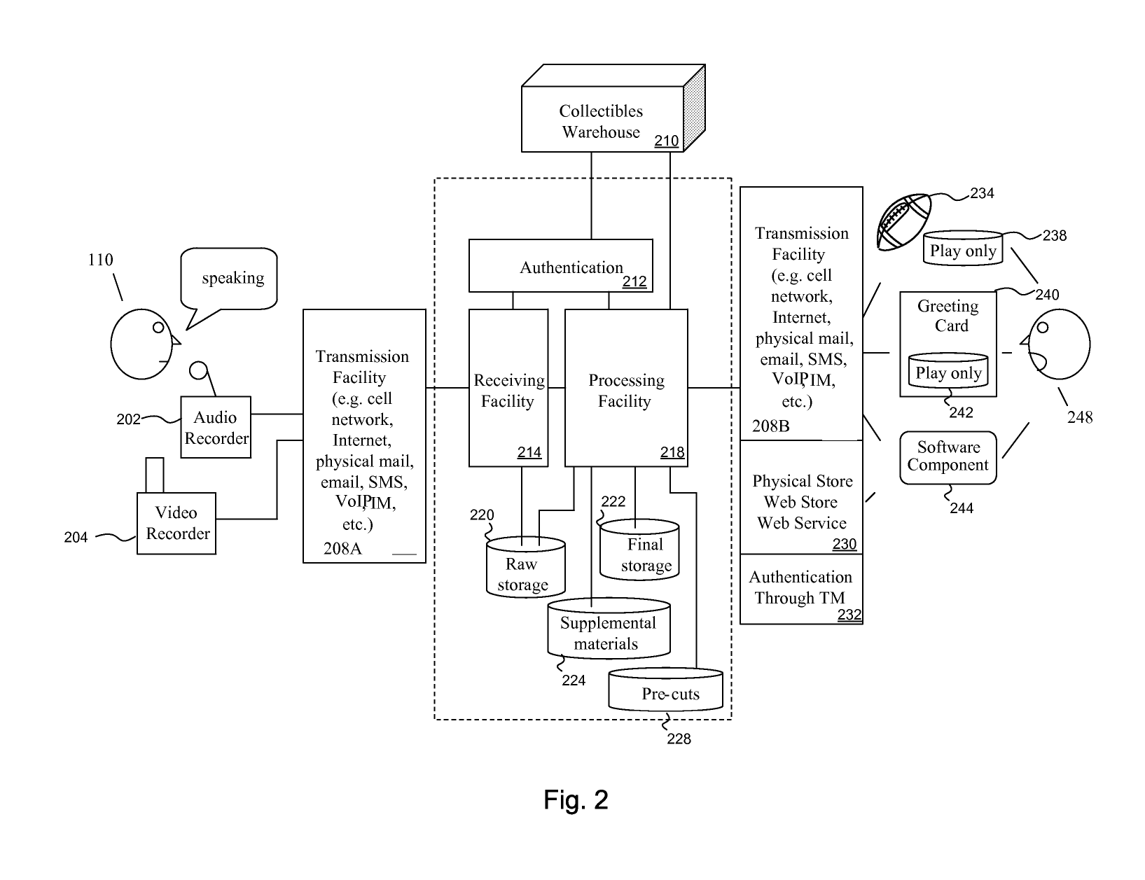

As illustrated in FIG. 2, in an embodiment, the character, person, celebrity, or other notable person 110 may use recording equipment, such as an audio recorder 202 and/or video recorder 204 that is available to the character, person, celebrity, or other notable person 110 to make a recording. A recording may be created through the intentional participation of a character, person, celebrity, or other notable person 110 (e.g., speaking directly into a microphone for the express purpose of making a recording), or passively. Examples of a character, person, celebrity, or other notable person 110 passively creating a recording may include, but is not limited to, a recording of a person made without his immediate awareness of being recording during the creation of the recording, a vintage recording of a character, person, celebrity, or other notable person 110 that was originally created for a purpose other than as an audiograph or videograph, or some other passive participation of a person 110 in a recording.

In embodiments, the recording made by an audio recorder 202 and/or video recorder 204 may be held in a format, such as in a digital format stored in memory, on magnetic tape, in a streaming digital format, or some other format. A recording from the recording equipment 202 or 204, in whatever format, may be sent using a transmission facility 208A. The transmission facility 208A and 208B may include a cellular phone network, the Internet, physical mail, email, SMS, VoIP, instant messaging, FTP, or some other facility capable of transmitting audio and/or video files. For example, a character, person, celebrity, or other notable person 110 may make a recording on a cell phone and transmit that digital format recording over the cellular network to a receiving facility 214. In another example, a character, person, celebrity, or other notable person 110 may transmit a videograph by shipping a DVD to a receiving facility using ground mail.

In embodiments, the recording may be received through the transmission facility 208A by a receiving facility 214. One example of a receiving facility 214 is a server that is capable of receiving digital recordings. The receiving facility 214 may be associated with a raw storage facility 220 in which it may store the received recordings for future use. The receiving facility 214 may be associated with an authentication facility 212 that may be used to authenticate the recording. As one example, authentication 212 may include checking the IP address or other coded information representing the origin of the recording against a list of accepted locations. A receiving facility 214 may be associated with a processing facility 218 that is capable of handling and/or manipulating received recordings. For example, a processing facility 218 may direct a recording into a raw storage facility 220 and/or a final storage facility 222. Such storage facilities may serve as holding stations for a backlog of recording material that may be used in the future for associating with collectibles, as demand requires. These storage facilities (220, 222) may also hold recordings while the authentication process occurs, or be used for some other storage purpose.

In embodiments, a processing facility 218 may be associated with a facility for supplemental materials 224. Examples of supplemental material 224 may include, but is not limited to, other recorded material, such as a video or audio recording, digital files, such as “frames” for digital images, branded material like logos, or some other supplemental material. A processing facility 218 may be associated with a facility for pre-cuts 228 of audio materials that may be combined with received recordings to create new recordings to associate with collectibles from a collectibles warehouse 210. Pre-cuts 228 may include pre-recorded audio segments of a character, person, celebrity, or other notable person 110 saying common phrases that may be used more than once, such as “happy birthday,” “congratulations,” or other common sentiments. In embodiments, the pre-cuts may be names of individuals, groups or organizations. The recording and storage of pre-cuts 228 may reduce the work load on a character, person, celebrity, or other notable person 110 making recordings insofar as the oft repeated segments of the audio need not be repeated.

In embodiments, a collectibles warehouse 210 may store collectibles for combining with audiographs and/or videographs. A collectibles warehouse 210 may be a plurality of locations in which collectibles are found.

The processing facility 218 may cause the received Audiograph/videograph to be authenticated, spliced into or with other materials from the pre-cut and/or supplemental materials databases 224 and/or 228 and associated with a collectible from the collectible warehouse 210. As indicated elsewhere herein, the Audiograph/videograph may also or instead be delivered as a collectible in and of itself. Once the collectible is in a condition for delivery, a transmission facility 208B may be used to communicate the collectible to the intended recipient 248. While the transmission facility 208B may be adequate for communicating electronic versions of the collectibles, other distribution facilities may be used in delivering collectibles to the intended recipient 248. For example, a physical store, web store, web service or other such distribution facility 230 may be used to transfer the collectible to the intended recipient 248. In embodiments, the distribution system may be associated with a known trademark 232 such that a recipient has confidence in the authentic nature of the collectible/Audio graph/video graph.

As indicated in FIG. 2, the distribution system may be adapted to deliver physical items such as collectibles 234 associated with audiographs/videographs 238, greeting cards 240 with audiographs/videographs 242, software components containing audiographs/videographs 244 or other forms of collectibles. As illustrated, the audiographs/videographs may be stored in user play only memory 236 and 242. In other embodiments, the memory may be unprotected and may include a write provision.

Generally, referring to FIG. 1 and FIG. 2, the recording may be received 118 from the character, person, celebrity, or other notable person 110 location using a digital recorder, an Ipod, a Dictaphone, a portable dictation machine, a portable audio player, an Mp3 player, a phone line, a telephone, a mobile phone, a cellular phone, a GSM phone, a personal computer, a handheld recorder, a preexisting recording, a new recording and a preexisting recording, and the like. The recording may be received from a cellular phone; the cellular phone records an audio file for future transfer using the cellular phone.

In an embodiment, the recording 102 or received recording 118 may be an audio recording, a video recording, a combination audio and video recording, or the like.

In an embodiment, an audiograph (104,120) may be any audio recording that is created by a character, person, celebrity, or other notable person 110 for the purposes of associating the audio recording with a collectible 114. In an embodiment, the audiograph 102 120 may be recorded in a first audio format and transferred, re-recorded, saved, or the like to at least one different format for the purposes of associating the audiograph to the collectible. For example, the character, person, celebrity, or other notable person 110 may create a recording 102 or a received recording 118 using a magnet audiotape such as a cassette tape. Attachment of a cassette tape to a collectible may be impracticable; therefore the recording 102 or received recording 118 may be transferred to another format that is more easily associated to the collectible 114. In an embodiment, the audiograph (104,120) may be transferred to an electronic memory device such as a flash memory.

In an embodiment, the audiograph (104,120) may be associated with a playing device that may include the electronic memory device, a speaker, a player device to play the audio, a power source, and the like. In an embodiment, the audiograph (104,120) may be played by a person by pressing a button, moving a part of the collectible 114, moving the collectible 114, making a sound near the collectible 114 (e.g. sound activation), or the like. In an embodiment, the audiograph (104,120) may be a self contained device that may be attached to the collectible 114, incorporated into the collectible 114, associated with the collectible 114 (e.g. an attached tag), on a separate document that is matched to the collectible 114, or the like.

In another embodiment, the audiograph (104,120) may be a recording that is provided to the collector on a recorded medium that may include audiotape, CD, MP3 format, or the like. In an embodiment, the audiograph (104,120) recording may be matched to the collectible 114 to indicate to the collector that the audiograph (104,120) and collectible 114 are associated. For example, a audiograph (104,120) CD may be provided to the collector that may have a serial number on the CD, a serial number as part of the audiograph (104,120), a serial number on the collectible 114, and the like to show that the audiograph (104,120) and the collectible 114 are associated.

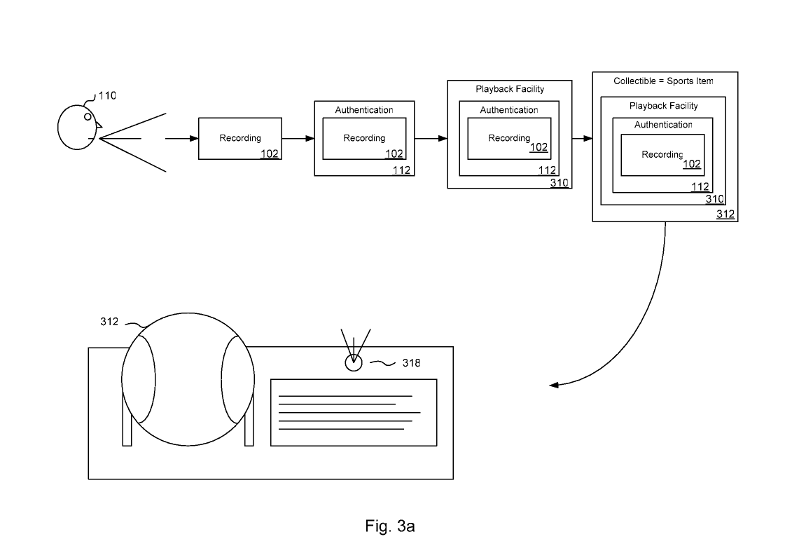

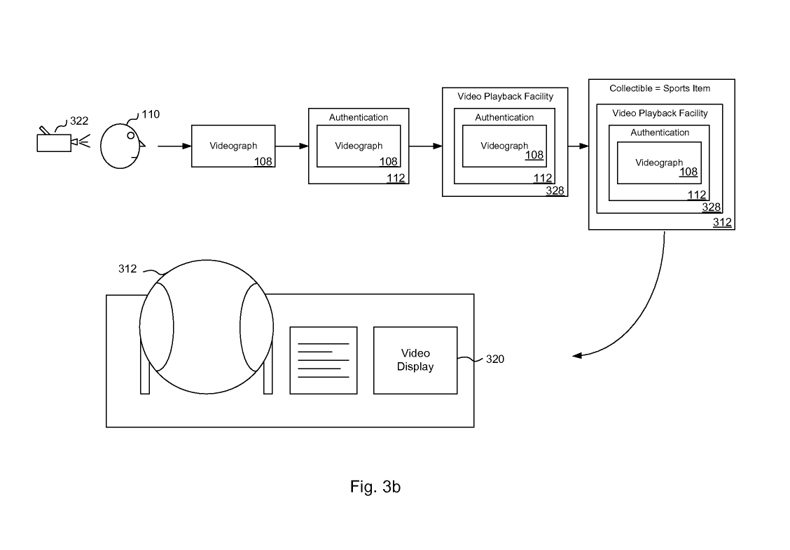

As illustrated in FIG. 3a, in an embodiment, a character, person, celebrity, or other notable person 110 may create a recording 102 using any of the methods and systems as described herein. The recording 102 may be associated with authentication 112, as described herein, and the authenticated recording further associated with a playback facility 310 that is enabled to play the recording 102. The authenticated recording 102 and playback facility 310 may be associated with a sports item 312, such as a baseball or some other sports item. The sports item 312 may, in one embodiment, be displayed in association with a playback facility 318 that is capable of playing the recording 102. The recording 102 may be activated to play through the playback facility 318 using any of the techniques and processes described herein.

As illustrated in FIG. 3b, a character, person, celebrity, or other notable person 110 may create a videograph 108 using any of the methods and systems as described herein. The videograph 108 may be associated with authentication 112, as described herein, and the authenticated recording further associated with a video playback facility 328 that is enabled to play the videograph 108. The authenticated videograph 108 and playback facility 312 may be associated with a sports item 312, such as a baseball or some other sports item, and the video made viewable by using a video display facility 320 that is associated with the collectible 114.

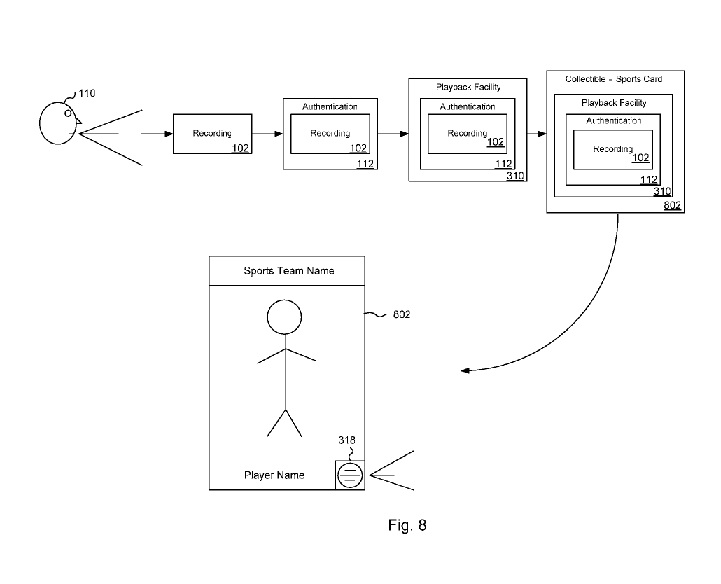

As shown in FIG. 8, a character, person, celebrity, or other notable person 110 may create a recording 102 using any of the methods and systems as described herein. The recording 102 may be associated with authentication 112, as described herein, and the authenticated recording further associated with a playback facility 310 that is enabled to play the recording 102. The authenticated recording 102 and playback facility 310 may be associated with a sports card 802. The sports card 802 may, in one embodiment, be displayed in association with a playback facility 318 that is capable of playing the recording 102. The recording 102 may be activated to play through the playback facility 318 using any of the techniques and processes described herein.

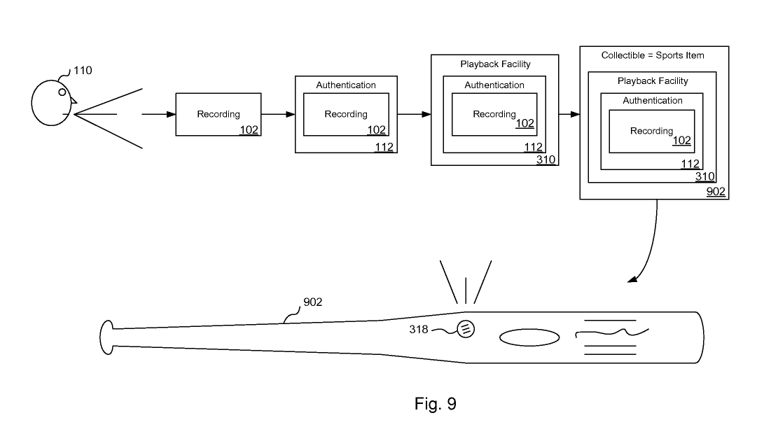

As shown in FIG. 9, a character, person, celebrity, or other notable person 110 may create a recording 102 using any of the methods and systems as described herein. The recording 102 may be associated with authentication 112, as described herein, and the authenticated recording further associated with a playback facility 310 that is enabled to play the recording 102. The authenticated recording 102 and playback facility 310 may be associated with a sports item 902, such as a bat, in which a playback facility 318 is joined to the sports item 902. The sports item 902 may, in one embodiment, be displayed in association with a playback facility 318 that is capable of playing the recording 102. The recording 102 may be activated to play through the playback facility 318 using any of the techniques and processes described herein.

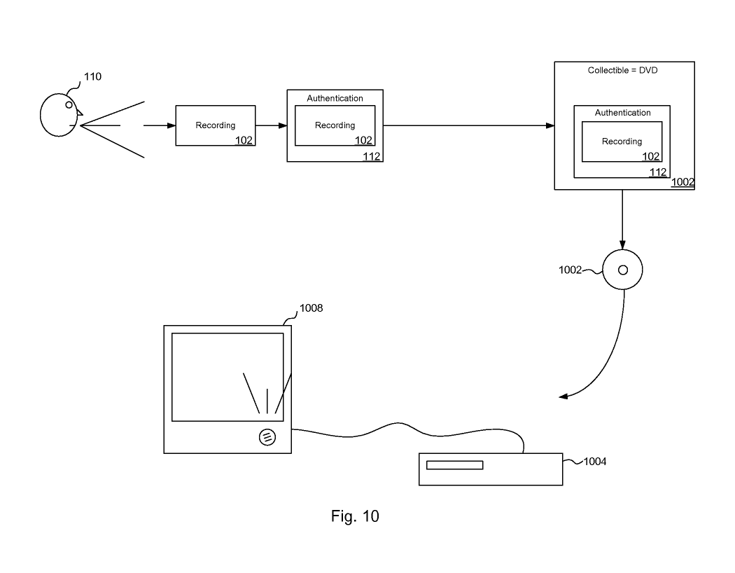

As illustrated in FIG. 10, a character, person, celebrity, or other notable person 110 may create a recording 102 using any of the methods and systems as described herein. The recording 102 may be associated with authentication 112, as described herein, and the authenticated recording further associated with a DVD 1002. The DVD 1002 may be played on a DVD player 1004, such as a DVD component, a personal computer, a portable DVD player, or some other device capable of playing a DVD. The DVD player 1004 may be attached to a viewing monitor 1008 on which the recording 102 may be viewed.

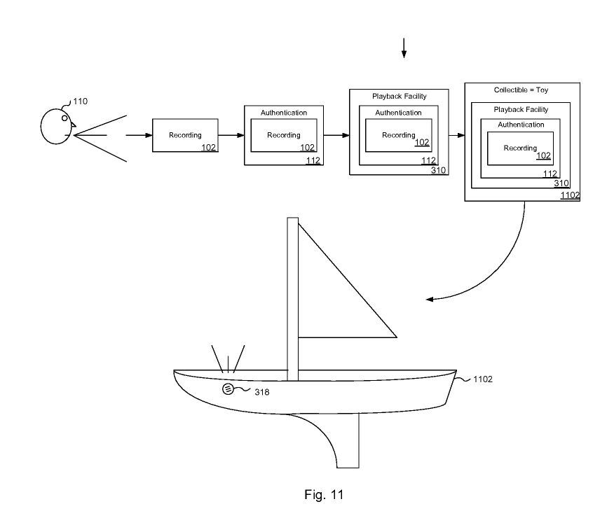

As shown in FIG. 11, a character, person, celebrity, or other notable person 110 may create a recording 102 using any of the methods and systems as described herein. The recording 102 may be associated with authentication 112, as described herein, and the authenticated recording further associated with a playback facility 310 that is enabled to play the recording 102. The authenticated recording 102 and playback facility 310 may be associated with a toy 1102. The toy 1102 may, in one embodiment, be displayed in association with a playback facility 318 that is capable of playing the recording 102. The recording 102 may be activated to play through the playback facility 318 using any of the techniques and processes described herein.

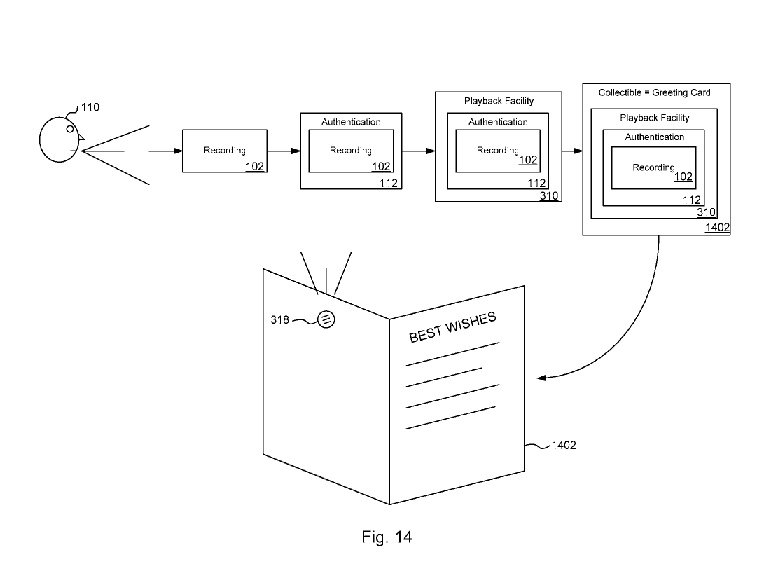

As illustrated in FIG. 14, a character, person, celebrity, or other notable person 110 may create a recording 102 using any of the methods and systems as described herein. The recording 102 may be associated with authentication 112, as described herein, and the authenticated recording further associated with a playback facility 310 that is enabled to play the recording 102. The authenticated recording 102 and playback facility 310 may be associated with a greeting card 1402. The greeting card 1402 may, in one embodiment, be displayed in association with a playback facility 318 that is capable of playing the recording 102. The recording 102 may be activated to play through the playback facility 318 using any of the techniques and processes described herein.

Generally referring to FIG. 1, a videograph (108,122) may be any video recording that is created by a character or person 110 for the purposes of associating the video recording with a collectible 114. In an embodiment, the videograph (108,122) may be recorded in a first video format and transferred, re-recorded, saved, or the like to at least one different format for the purposes of associating the videograph to the collectible. For example, the character or person 110 may create a recording 102 or a received recording 118 using analog videotape such as an 8 mm tape. In an embodiment, the videograph (108,122) may be transferred to an electronic memory device such as a flash memory.

In an embodiment, the videograph (104,120) may be associated with a playing facility 318 that may include the electronic memory device, a speaker, a display, a player device to play the audio, a power source, and the like. In an embodiment, the videograph (104,120) may be played by a person by pressing a button, moving a part of the collectible 114, moving the collectible 114, making a sound near the collectible 114 (e.g. sound activation), or the like. In an embodiment, the videograph (104,120) may be a self contained device that may be attached to the collectible 114, associated with the collectible 114 as an attachment, as a separate play device that is matched to the collectible 114, incorporated into the collectible 114, or the like.

In another embodiment, the videograph (108,122) may be a recording that is provided to the collector on a recorded medium that may include a VCR tape, a CD, a VCD, a DVD, or the like. In an embodiment, the videograph (108,122) recording may be matched to the collectible 114 to indicate to the collector that the videograph (108,122) and collectible are associated. For example, as illustrated in FIG. 10, a character, person, celebrity, or other notable person 110 may make a recording 102, such as a videograph (108,122) for distribution as, or combination with, a DVD 1002. The DVD 1002 may contain only the recording 102, or the recording 102 in combination with some other audio and/or visual media. The recording 102 may be associated with authentication 112 prior to, during, or after inclusion with a DVD 1002. The DVD 1002 provided to the collector may have a serial number on the DVD 1002, a serial number as part of the videograph (108,122), a serial number on the collectible 114, and the like to show that the videograph 108 and the collectible 114 are associated. The DVD 1002 containing the recording 102 and authentication 112 may be played on any DVD player facility 1004, such as a stand alone DVD component, a DVD player facility 1004 associated with a personal computer, a DVD player facility 1004 associated with a portable device, or some other DVD player facility 1004. The DVD 1002 may be presented on any audio-visual playback facility 1008, such as a television monitor, a computer monitor, plasma screen, LCD, projection screen, or some other audio-visual playback facility 1008.

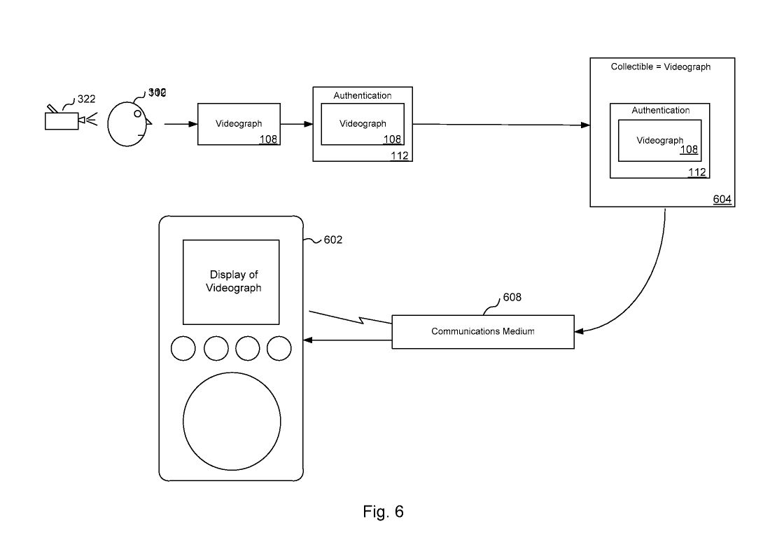

As illustrated in FIG. 6, in another embodiment, a character, person, celebrity, or other notable person 110 may create a videograph 108 using any of the methods and systems as described herein. The videograph 108 may be a recording, made by any video recording-capable device 322 in a recorded medium that may include a format that is compatible with a portable video player 602 (e.g., an iPod). The videograph 108 may be associated with authentication 112, as described herein, and the authenticated recording, a collectible videograph 604, further associated with a communications medium 608. A communications medium 608 may be a transmission facility 208, such as a cellular phone network, the Internet, physical mail, email, SMS, VoIP, instant messaging, FTP, or some other facility capable of transmitting audio and/or video files. A portable video player 602 may be able to download, stream, or receive and display the videograph 108 in some other manner by using either a wireless or wired connection that is associated with the communications medium 608.

In an embodiment, a video recording 108 that is received from a person, character, celebrity or some other notable person 110 using any of the methods and systems as described herein, may be associated with a portable video player 602 on which the videograph 108 may be viewed. A portable video player 602 may be a device such as an iPod, a mobile communication facility, such as a cellular phone, and the like, or some other portable video player 602. For example, a celebrity, such as an athlete, may make a videograph 108 in which he offers a personalized greeting, describes a famous sporting event in which he was a participant as the video footage of the event is displayed, or some other video recording type. A user may receive the video recording 508 and download it onto a portable video player 602, where it may be stored for future viewing. In an alternate embodiment, the videograph 108 may be further associated with usage rights that in some manner limit the viewing privileges of users. For example, a videograph 108 may be made available to viewers on a Pay-per-view basis in which a financial fee is paid for a single viewing, or a fee is paid for each viewing and/or download of the video.

In an embodiment, for portable video players 602 which are networked using, for example, a communications medium 608 (e.g., wireless network), the video recording may be stored on a remote server and streamed to the player 602 for viewing.

Referring to FIG. 1, the recording 102 or received recording 118 may be provided by the character, person, celebrity, or other notable person 110 based on a standard text about a certain collectible 114, based on standard text to a collector of the collectible 114, or the like. For example, the character or person 110 may use a non-personal greeting to the collector of the collectible 114 such as “Hello, the collectible you have is number XX and was made special for you”. In another example, the character, person, celebrity, or other notable person 110 may use a standard set of names that may be used with the recording to make the recording more personal such as “Hello John, the collectible you have is number XX and was made special for you”. In an embodiment, the standard set of names may be recorded as part of the full text the character or person is reading for the recording 102 or received recording 118.

In another embodiment, the standard set of names may be omitted from the full text recorded by the character, person, celebrity, or other notable person 110. The standard set of names may be recorded separately and merged into the recording for the collectible 114. For example, the recording for the collectible may be “Hello”, “the collectible you have is number XX and was made special for you” with the name left out of the recording. The character, person, celebrity, or other notable person 110 may record a standard set of names as separate recordings and the text and the names may be merged together when a recording is requested for a collectible 114. For example, when John request a recording, the total recording may be “Hello”, “John”, “the collectible you have is number XX and was made special for you”. In this manner, the recording may sound personalized and new names may be added at any time to the set of separate recordings.

In another embodiment, a collector requested 124 recording may be requested for the character, person, celebrity, or other notable person 110 to record a particular greeting for a collectible 114 or collector. In an embodiment, the collector request 124 may be a written request, an email request, a request through a website, a phone request, a text message request, an instant message request, a chat room request, or the like. In an embodiment, a collector may desire a personalized recording 102 from the character, person, celebrity, or other notable person 110. For example, a person may wish to have a personalized recording 102 118 for a collectible 114 that will be given as a birthday gift. The collector requested 124 recording (102, 118) may be “Hello John, this collectible is given to you on your birthday”. In an embodiment, the collector requested 124 recording may be any recording text.

In an embodiment, once the audiograph (104,120) or videograph (108,122) have been created from the recording 102 or received recording 118, they may be associated with the collectible 114. In an embodiment, the audiograph (104,120) and videograph (108,122) may be associated with a new collectible 114, an existing collectible 114, a collectible 114 already owned by a collector, or the like.

In an embodiment, new collectibles 114 may be offered for sale with a choice of audiograph (104,120) and/or videograph (108,122). In an embodiment, there may be a plurality of audiographs (104,120) and/or videographs (108,122) available for a collectible 114. A collector may be able to choose from one of the plurality of audiograph (104,120) and/or videograph 104 122 recordings for the collectible 114. The collector may be able to choose the audiograph (104,120) and/or videograph (108,122) for a collectible at locations that may include an enterprise, a website, a collectible show, in person with the character, person, celebrity, or other notable person 110.

In an embodiment, the audiograph (104,120) and/or videograph (108,122) may be selected for an existing collectible 114 that the collector may already own. The collector may be able to choose the audiograph (104,120) and/or videograph (108,122) for a collectible at locations that may include an enterprise, a website, a collectible show, in person with the character, person, celebrity, or other notable person 110. In an embodiment, the collector may indicate the collectible 114 already owned to request an appropriate audiograph (104,120) and/or videograph (108,122) from the character, person, celebrity, or other notable person 110. In an embodiment, the collectible 114 authenticity may be verified before an audiograph (104, 120) and/or videograph (108, 122) is provided to the collector.

In an embodiment, the audiograph (104,120) and videograph (108,122) may be distributed 128 to collectors using enterprises, websites, collector shows, meetings with the character, person, celebrity, or other notable person 110. In an embodiment, the audiograph (104,120) and videograph (108,122) may be part of a new collectible 114, integrated into the collectible 114, on the collectible 114, attached to the collectible 114, as a separate item from the collectible 114, or the like. For example, an audiograph (104,120) may be integrated into the collectible 114 with the playing device inside the collectible 114 using an external actuation to play the audiograph (104,120). In another example, the videograph (108,122) may be a DVD that is provided as a separate item that may be matched to the collectible 114.

In an embodiment, audiographs (104,120) and/or videographs (108,122) may be distributed 128 to existing collectibles 114. In an embodiment, the audiograph (104,120) and/or videograph (108,122) may be an item that may be attached to the collectible 114, connected to the collectible 114 (e.g. a tag), provided as a separate item for the collectible 114 (e.g. CD or DVD), or the like. In an embodiment, the collector may need to show that the collectible is an authentic collectible 114 for the character, person, celebrity, or other notable person 110 for which the audiograph (104,120) and/or videograph (108,122) is being requested. In an embodiment, the collector may associate the audiograph (104,120) and/or videograph (108,122) to the collectible or a certified person may attach the audiograph (104,120) and/or videograph (108,122); the certified person may be a person authorized by the character or person 110.

Once the audiograph (104,120) and/or videograph (108,122) have been associated with a collectible 114, the collector may desire to authenticate 112 that the audiograph (104,120) and/or videograph (108,122) and collectible 114 combination is authentic. In an embodiment, the authentication 112 may be based at least in part on an IP address, a dedicated telecommunications connection, a password protected access, an encrypted channel, a voice spectrum analysis, a voiceprint, a digital signature, a brand, a distribution channel, a sales channel, or the like. The dedicated telecommunications connection may be a phone line, a wireless connection, or the like. For example, the collector may call a phone number and provide information about the collectible to receive authentication 112 information about the collectible. In another example, the collector may use a website to authenticate 112 the collectible 114 by entering information about the collectible 114 and receiving authentication 112 information about the collectible.

In an embodiment, the collectible 114 audiograph (104,120) and/or videograph (108,122) combination may further be identified with a mark that may associate the collectible 114 combination to an organization, association, group, or the like. In an embodiment, the mark 134 may be a trademark, symbol, or the like. The trademark may be a word, a motto, a logo, a graphic, a service mark, or the like. For example, the collectible 114 may have the mark of Major League Baseball (MLB®), this may indicate that the audiograph (104,120) and/or videograph (108,122) may be an authentic MLB® collectible in addition to the audiograph (104,120) and/or videograph (108,122) authenticity. In an embodiment, the collectible 114 authentication 112 may be verified by the organization, association, group, or the like that has placed its mark on the collectible 114; the verification may be for the mark and the audiograph (104, 120) and/or videograph (108, 122).

In an embodiment, the collectible 114 audiograph (104,120) and/or videograph (108,122) combination may have a unique traceable identifier 130 to provide an authentication 112. In an embodiment, the unique traceable identifier 130 may be a bar code, a serial number, an image, a logo, a stamp, a unique seal, an audio message, an RFID tag, a magnetic tag, or the like.

In an embodiment, the unique traceable identifier may include a digital analytic profile 130. The digital analytic profile 130 may include a measure of frequency; the frequency may be measured at multiple temporal points in the audio segment. The digital analytic profile may include a measure of amplitude; the amplitude may be measured at multiple temporal points in the audio segment. The digital analytic profile may include a measure of time. In an embodiment, the digital analytic profile may provide a method of verifying that the audio part of the audiograph (104,120) and videograph (108,122) may be the authentic audio of the character, person, celebrity, or other notable person 110. In an embodiment, there may be a standard digital analytic profile 130 provided for each character or person audiograph (104,120) and videograph (108,122). The collectible 114 digital analytic profile may be compared to the standard digital analytic profile for authentication 112 of the audiograph (104, 120) and videograph (108, 122).

In an embodiment, a website registry 132 may be used to verify the authenticity 112 of a collectible 114 unique traceable identifier and digital profile 130. In an embodiment, the website registry 132 may be searchable and may have information that may include a digital audio provide, serial numbers, logo, symbol, seal, unique traceable identifier 130, or the like. In an embodiment, the website registry 132 may be available to any collector, may be password protected, may be controlled by an enterprise, may be controlled by an organization, may be organized by a club, or the like. The collector may be able to use the website registry 132 to provide collectible 114 authentication 112 using the digital audio provide 130, a serial number, a logo, a symbol, a seal, the unique traceable identifier 130, or the like.

In an embodiment, a recording 102 may be any method of capturing audio information, video information, audio and video information, or the like onto an electronic medium, electronic storage device, or the like. In an embodiment, the capturing of audio, video, or the like may be by any type of device that may be capable of receiving audio, video, or the like and electronically storing the audio, video, or the like information onto a storage medium that may include magnetic tape, CD, DVD, phonograph record, hard drive, flash drive, or the like. In an embodiment, the recording 102 may be made using a digital recorder, an Ipod, a Dictaphone, a portable dictation machine, a portable audio player, an Mp3 player-microphone combination, a phone line, a telephone, a mobile phone, a cellular phone, a GSM phone, a personal computer, a handheld recorder, a preexisting recording, a new recording and a preexisting recording, and the like. The recording may be made using a cellular phone; the cellular phone may record an audio file for future transfer using the cellular phone.

In an embodiment, the recording 102 may be recorded on one type of medium and transferred to other types of mediums. For example, the recording 102 may be made on magnetic tape and transferred, re-recorded, copied, or the like to the flash drive memory. In an embodiment, the recording 102 may be recorded in an analog format and transferred, re-recorded, copied, or the like to a digital format. For example, the recording 102 may be recorded as an analog format on magnetic tape and transferred, re-recorded, copied, or the like to a digital format. In an embodiment, the conversion from an analog to digital format may use an analog to digital converter (ADC) for sampling the audio signal and creating a digital signal onto a digital medium.

In an embodiment, an audiograph 104 may be an audio recording 102 that may be used as an audio signature of a character, person, celebrity, or other notable person 110. In an embodiment, the audiograph 104 may be recognizable to a typical person as the audio recording 102 of the character, person, celebrity, or other notable person 110 that the audio indicates the recording 102 is from. For example, the audiograph 104 may have a voice characteristic, particular saying, or the like of the character, person, celebrity, or other notable person 110.

In an embodiment, a videograph 108 may be a video, video and audio, or the like recording 102 that may be used as a video signature of a character, person, celebrity, or other notable person 110. In an embodiment, the videograph 104 may be recognizable to a typical person as the video recording 102 of the character, person, celebrity, or other notable person 110 that the video indicates the recording 102 is from. For example, the videograph 104 may have a visual characteristic, particular saying, particular scene, movie clip, TV clip, or the like of the character, person, celebrity, or other notable person 110.

In an embodiment, a collectible 114 may be anything that may have monetary value, sentimental value, personal value, endorsed by a character, person, celebrity, or other notable person 110, previously owned by a character or person 110, previously used by a character, person, celebrity, or other notable person 110, be in the likeness of the character or person, or the like. In an embodiment, the collectible 114 may be purchased, received as a gift, any item with a character, person, celebrity, or other notable person 110 signature, a memento from an event, any item received from a character, person, celebrity, or other notable person 110.

In an embodiment, a collectible item may be a doll, a painting, a car, a picture, a new toy, a classic toy, a stuffed toy, a teddy bear, a lunch box, a record, a CD, a DVD, a sports card, a baseball card, a football card, a hockey card, a basketball card, a musical band card, a cup, a boat, a spoon, a stamp, a doll house, a scale house, a scale car, a plane, a scale plane, a vase, a musical instrument, a book, a bookmark, an action figure, a figurine, an ornament, an art print, an art painting, an art picture, a statue, a lapel pin, a magnet, a plaque, a magazine, a comic book, wine, a game, a baseball, a football, a hockey puck, a basketball, a softball, a soccer ball, furniture, or the like.

In an embodiment, the collectible 114 may be an item that a collector personally received from a character, person, celebrity, or other notable person 110, saved from an event, purchased, requested from the character, person, celebrity, or other notable person 110, or the like. In an embodiment, the collector may be a single person, a plurality of persons, an institution, a club, a collectibles merchant, or the like.

In an embodiment, the collectible may have a signature of the character or person 110, an indication of the character, person, celebrity, or other notable person 110 being at a particular event (e.g. an event ticket), an object in the likeness of the character or person 110, an item used by the character or person 110, an item associated with a character or person, or the like.

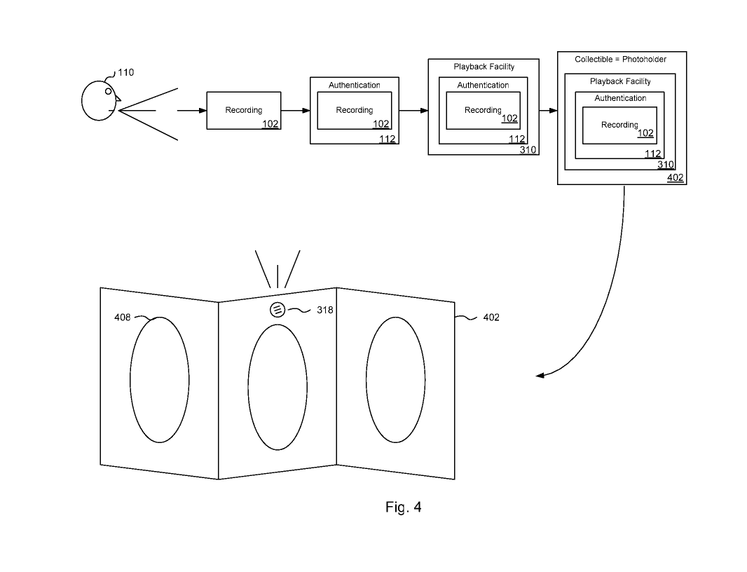

As illustrated in FIG. 4, in an embodiment, a character, person, celebrity, or other notable person 110 may create a recording 102 using any of the methods and systems as described herein. The recording 102 may be associated with authentication 112, as described herein, and the authenticated recording further associated with a playback facility 310 that is enabled to play the recording 102. The authenticated recording 102 and playback facility 310 may be associated with a photo holder. 402. A photograph holder 402 may be one of a plurality of types, such as a folding holder, a multi-panel holder, a bendable holder, or some other holder type. The recording 102 that is associated with the photograph holder 402 may be activated to play the recording 102 upon an interaction with the photograph holder 402. For example, in the instance of a folding photograph holder 402, the recording 102 may play upon opening the fold of the holder 402 in order to reveal the photograph that is displayed inside the holder 402.

In an alternate embodiment, a photograph holder 402 may have an activation button associated with it that, when depressed, causes the recording 102 to play.

In an alternate embodiment, a photograph holder 402 may have a motion detection system that may play the audio recording upon detection of motion in the vicinity of the photograph holder 402. For example, photograph holder 402 may be made to mount on a wall for viewing. Associated with the photograph holder 402 may be a light detection panel that activates the recording 102 when a shadow is cast over the panel, such as that cast by a person walking in front of the light detection panel. The photograph holder 402 may display a copy of the famous photo of Jackie Robinson's controversial steal of home on Yogi Berra, in which Robinson was ruled to be safe. As a person walking in front of the photo and its associated light detection panel, an audio recording may be activated in which Yogi Berra yells “Yer OUT!”

In an embodiment, a collectible 114 may have a monetary value and therefore may be traded, sold, purchased, or the like between collectors, individuals, groups, organizations, or the like. In an embodiment, the collector may invest in a particular collectible 114 to allow the value to increase in time and then sell the collectible 114 for a profit. In another embodiment, the collector may collect many items of a character, person, celebrity, or other notable person 110 for the pleasure of owning items that are associated with the character, person, celebrity, or other notable person 110 without the intention of selling the collectibles.

In an embodiment, the collectible 114 may not have monetary value but may have personal value by having been collected by a collector from an event, an activity, a location, or the like. For example, the collector may collect certain cartoon characters because of a fondness of that particular cartoon character and not because of the monetary value the cartoon character may have.

In an embodiment, a collectible 114 may be an individual item may be a group of items, or the like. For example, the collectible 114 may be a single baseball card or the collectible may be every baseball card for a particular season. In an embodiment, the collectible 114 may be valued differently if it is a single or a group of collectibles. A person knowledgeable in the art of collectibles 114 may understand the characteristics of collectibles that provides value to a particular collectible 114.

In an embodiment, authentication 112 may be any recognized indication that the collectible 114 is associated with a character, person, celebrity, or other notable person 110 and not an imitation collectible. In an embodiment, the authentication 112 may be based at least in part on an IP address, a dedicated telecommunications connection, a password protected access, an encrypted channel, a voice spectrum analysis, a voiceprint, a digital signature, a brand, a distribution channel, a sales channel, or the like. The dedicated telecommunications connection may be a phone line, a wireless connection, or the like

In an embodiment, the authentication 112 may be used to compare to a known indication of the character, person, celebrity, or other notable person 110. For example, the collectible 114 may have a serial number that may be verified to a known database of serial numbers that the character, person, celebrity, or other notable person 110 has indicated are authentic collectibles 110. In an embodiment, the authentication 112 may be received with the collectible 114, may be requested from the character or person 110 after receiving an item, may be received from a collectible expert, or the like.

In an embodiment, an authentication 112 on a collectible 114 may increase the value of the collectible 114 by a third person being able to verify the authentication 112 of the item before a purchase, trade, or the like. For example, a first collector may put a certain collectible 114 up for sale and a second collector, using the authentication provided by the first collector, may be able to verify that the collectible is associated with the character, person, celebrity, or other notable person 110.

In an embodiment, receiving a recording 118 may be any method of receiving the recording 102. In an embodiment, the recording may be received 118 from a digital recorder, an Ipod, a Dictaphone, a portable dictation machine, a portable audio player, an Mp3 player, a phone line, a telephone, a mobile phone, a cellular phone, a GSM phone, a personal computer, a handheld recorder, a preexisting recording, a new recording and a preexisting recording, and the like. The recording may be received from a cellular phone; the cellular phone records an audio file for future transfer using the cellular phone.

In an embodiment, an audio recording that is received from a person, character, or celebrity using any of the methods and systems as described herein, may be made available for listening in the form of a ringback tone, or ringtone, such as that used on a mobile communication facility. A ringtone may be a monophonic ringtone, a polyphonic ringtone, a TrueTone ringtone, a ringtone in a Tone Text Transfer Language (RTTL) format, a .wav file, or some other audio file type and/or format that is compatible with a mobile communication facility audio facility, and the like. A mobile communication facility may be a phone, a cellular phone, a mobile phone, a GSM phone, a satellite phone, or some other form of mobile communication facility.

For example, a character, person, celebrity, or other notable person 110, such as the actress Frances McDormand, may make an audio recording in the nasal, upper-Midwestern dialect she used in the movie Fargo which says, “Hey there Fella, ya gochyerself an incomin' call doncha know?” This recording may, in turn, be made into a ringtone file that is compatible for playing on a mobile communication facility. Once made available to a mobile communication facility, the McDormand audio file may be played to signal an incoming call.

In alternate embodiments, the audio file may be personalized to an individual user of mobile communication facility.

In alternate embodiments, multiple audio files may be recorded by a character, person, celebrity, or other notable person 110 for use as multiple ringtone files, each of which may be associated with an in-calling phone number, such as one audio file/ringtone associated with a mobile communication facility user's significant other, another audio file/ringtone with the user's ex-significant other, another audio file/ringtone with the user's employer, and so forth. In an embodiment, multiple person, character, or celebrity ringtones may be associated with multiple in-calling phone numbers, for example, an Angelina Jolie recording may be used as the ringtone for a user's significant other, Glenn Close for the user's ex, and Donald Trump for the user's employer.

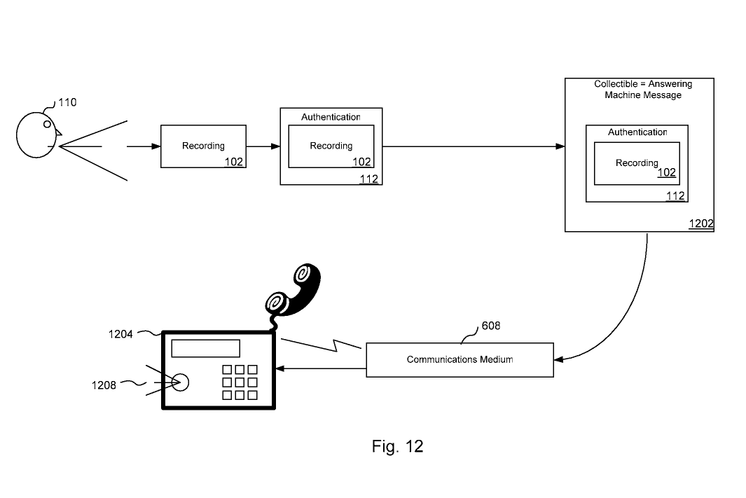

As illustrated in FIG. 12, in an embodiment, a character, person, celebrity, or other notable person 110 may create a recording 102 using any of the methods and systems as described herein. The recording 102 may be associated with authentication 112, as described herein, and used to create a collectible answering machine message 1202. The collectible answering machine message 1202 may be made available for placement on an answering machine 1204 by providing the collectible answering machine message 1202 to an individual, by directly recording the audio segment to an individual's answering machine 1204, or by some other transfer method using a communication medium 608, such as a transmission facility 208 as described herein. For example, a collectible answering machine message 1202 may be downloaded, transferred to, made available to, or otherwise associated with an answering machine 1204 through the use of a telecommunications landline, a cellular telecommunications system, a satellite communications system, a wireless communications system, the Internet, an intranet, a web service, a microphone, a broadcast, a signal transmission, or some other means of communication. The collectible answering machine message 1202 made by the character, person, celebrity, or other notable person 110 may be a generic message in which the character, person, celebrity, or other notable person 110 identifies him- or herself, or the recording may be personalized for an individual, a group, or some other conglomeration of persons or entities. The collectible answering machine message 1202 may be made audible by a playback facility 1202 associated with an answering machine 1208.

In an embodiment, a received recording 118 may be received on one type of medium and transferred to other types of mediums. For example, the received recording 118 may be made on magnetic tape and transferred, re-recorded, copied, or the like to the flash drive memory. In an embodiment, the received recording 118 may be recorded in an analog format and transferred, re-recorded, copied, or the like to a digital format. For example, the received recording 118 may be recorded as an analog format on magnetic tape and transferred, re-recorded, copied, or the like to a digital format. In an embodiment, the conversion from an analog to digital format may use an analog to digital converter (ADC) for sampling the audio signal and creating a digital signal onto a digital medium.

In an embodiment, a character, person, celebrity, or other notable person 110 may be anyone, when associated with a collectible 114, enhances the value of the collectible 114. In an embodiment, a character, person, celebrity, or other notable person 110 may be associated with a collectible if the character, person, celebrity, or other notable person 110 signs the collectible 114, the collectible 114 resembles the character or person 110, the character, person, celebrity, or other notable person 110 endorses the collectible, or the like.

In an embodiment, the character, person, celebrity, or other notable person 110 may be an athlete. The athlete may be a professional athlete, a baseball player, a football player, a hockey player, a basketball player, a soccer player, a boxer, a golfer, a wrestler, a skier, a tennis player, a swimmer, a polo player, a driver, a rugby player, a lacrosse player, a track and field athlete, a jockey, a wheelchair athlete, a former player, a current player, a retired player, a collegiate athlete, an Olympic athlete, Special Olympic athlete, an amateur athlete, or the like.

In an embodiment, the character, person, celebrity, or other notable person 110 may be an actor. The actor may be a movie actor, a theater actor, a TV actor, a voiceover actor, a commercial actor, a broadcaster, or the like.

In an embodiment, the character, person, celebrity, or other notable person 110 may be a musician, an artist, a political figure, a military figure, a scientist, an activist, a historical figure, a news personality, a commentator, or the like.

In an embodiment, the character, person, celebrity, or other notable person 110 may be a fictitious character. The fictitious character may be a movie character, a television character, a cartoon character, a theatrical character, or the like.

In an embodiment, the character, person, celebrity, or other notable person 110 may be associated to the collectible 114 by a signature, mark 134, unique traceable identifier 130, audiograph (104,120), videograph (108,122), or the like.

In an embodiment, a collector request 124 may be a request from a collector for a recording 102 from a character, person, celebrity, or other notable person 110. In an embodiment, the collector request 124 may be a written request, an email request, a request through a website, a phone request, a text message request, an instant message request, a chat room request, or the like. In an embodiment, a collector may desire a personalized recording 102 from a character, person, celebrity, or other notable person 110 that may be associated with a collectible 114. In an embodiment, the collector may request a personalized recording 102, a general recording 102, a selectable recording 102 (e.g. a recording choice on a website), or the like. In an embodiment, the personalized recording may be for a particular collectible 114, a group of collectibles 114, a type of collectible 114, or the like.

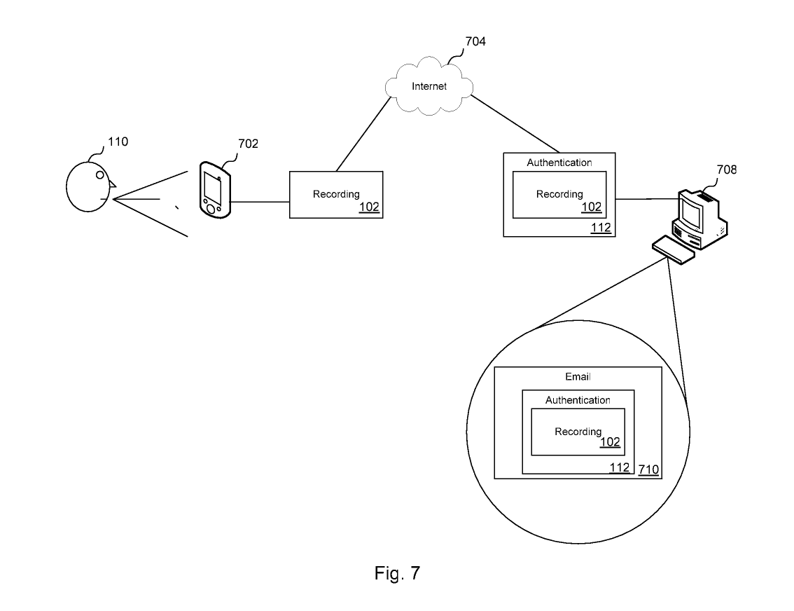

As illustrated in FIG. 7, a recording 102 may be made by a character, person, celebrity, or other notable person 110 using a recording device 702 or any of the methods and systems as described herein. The recording 102 may be sent through any transmission facility 208 described herein, such as the Internet 704, and may use a wired or wireless connection for the transmission. The recording 102 may be associated with authentication 112 prior to, during, or after transmission, and further associated with an email 710. The association with the email 710 may be made prior to, during, or after the authentication 112. The email 710 may be delivered to an intended recipient for viewing on a personal computer 708 or any other device that is capable of receiving email 710, such as a cell phone, blackberry, laptop, or some other device capable of receiving email. The recording 102, with or without authentication 112 may be the only media contained in the email 710, or it may be associated with other media content with the email 710, such as text, audio, video, graphics or some other media content.

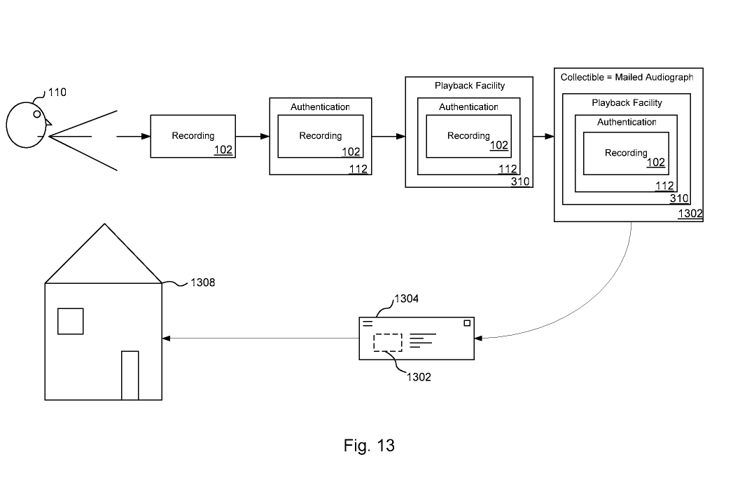

As shown in FIG. 13, in an embodiment, a character, person, celebrity, or other notable person 110 may create a recording 102 using any of the methods and systems as described herein. The recording 102 may be associated with authentication 112, as described herein, and the authenticated recording further associated with a playback facility 310 that is enabled to play the recording 102. The authenticated recording 102 and playback facility 310 may be associated with a mailed audiograph 1302. The mailed audiograph 1302 may, be delivered to an intended recipient at a location, such as a residence 1308, using ground mail wherein the recording 102 is shipped in a physical package, such as a letter 1304. The mailed audiograph 1302 may be an embodiment that contains a recording 102 and a playback facility 318 that may enable the intended recipient to listen to the mailed audiograph 1302 upon opening the letter 1304. As with the mailed audiograph 1302, a videograph 108 may use a similar ground mail procedure for distributing videographs to intended recipients.

In an embodiment, a mark 134 may be any type of indication that may be associated with the character, person, celebrity, or other notable person 110, an organization, association, or the like. In an embodiment, the mark 134 may be a trademark, symbol, or the like. The trademark may be a word, a motto, a logo, a graphic, a service mark, or the like. In an embodiment, the mark 134 may be associated with a group, an organization, an association, an organization related to character, person, celebrity, or other notable person 110 activities, or the like. For an example, the mark 134 may be the trademark for Major League Baseball and the mark 134 on the collectible 114 may indicate that the collectible 114 may be approved or authorized by Major League Baseball. In an embodiment, the mark 134 may be associated with the collectible 114.

In an embodiment, a recording 102 that is received from a person, character, or celebrity using any of the methods and systems as described herein, may be associated with a merchandise tag 502. The recording 102 that is associated with the merchandise tag 502 may be made by a person, character, or celebrity bearing some relationship to the article of merchandise. The presence of the recording 102 with the tag 502 may serve to imbue the article of merchandise 504 with personalization, information, and the like.

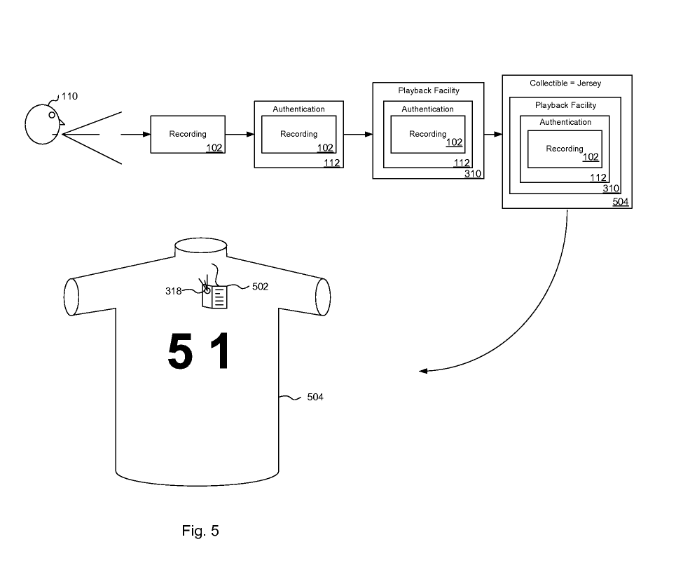

As illustrated in FIG. 5, in an embodiment, a character, person, celebrity, or other notable person 110 may create a recording 102 using any of the methods and systems as described herein. The recording 102 may be associated with authentication 112, as described herein, and the authenticated recording further associated with a playback facility 310 that is enabled to play the recording 102. The authenticated recording 102 and playback facility 318 may be associated with a merchandise tag 502, such as that used on a jersey 504. For example, a celebrity, such as an athlete like baseball player David Ortiz may make a recording 102 that is associated with the merchandise tags 502 used on merchandise, such as baseball jerseys 504 bearing his number and team logo. Upon opening a folded tag 502, moving a tag 502, touching a tag 502, or carrying out some other form of interaction with the tag 502, the interacting party (e.g., a customer interested in purchasing a jersey) may hear the audio recording made by David Ortiz in which he says, for instance, “Hi, I'm David Ortiz. I'm honored to have great fans like you wear my jersey. Go Red Sox!”

In an alternate embodiment, an article of fashion designed by a well-known designer such as Donna Karan, may feature a tag 502 that is associated with a recording 102 of Ms. Karan describing the thought behind the article's design, its significance, and the like.

In an alternate embodiment, an audio recording 204 may be made by a person, character, or celebrity that is associated with qualities which may assist with a consumer's decision making regarding a product purchase. For example, Bob Villa is well-known as the former host for the program This Old House in which derelict homes were refurbished by skilled craftsman, of which Bob Villa was one. In an embodiment, a celebrity and/or knowledgeable spokesperson may make a recording 102 in which he identifies himself and speaks about the particular qualities of a given product and why it is well-suited for purchase. This recording 102 may be associated with a merchandise tag 502 affixed to or near the product 404 that is the subject of the recording 102. The recording 102 may play upon some form of user interaction with the merchandise tag 502 using any of the systems and methods described herein.

In an embodiment, the collectible 114 may have a unique traceable identifier 130 that may be a physical identifier, an audio identifier, an electronic identifier, or the like. In an embodiment, the unique traceable identifier 130 may uniquely identify the collectible with a collector able to verify the unique traceable identifier 130 using an external verification source that may include a collector's guide, a collectors catalog, a website, or the like.

The unique traceable identifier 130 may be a bar code, a serial number, an image, a logo, a stamp, a unique seal, an audio message, an RFID tag, a magnetic tag, or the like.

In an embodiment, the unique traceable identifier 130 may be attached directly to the collectible 114, be a separate document from the collectible 114, be loosely attached to the collectible 114, or the like. In an embodiment, if the unique traceable identifier 130 is a separate document, there may be a common identifier between the unique traceable identifier 130 and the collectible 114 that may include a serial number, a signature, a stamp, a unique seal, or the like.

In an embodiment, a website registry 132 may be a website where a collector may be able to search for authentication of a collectible 114. In an embodiment, the website registry 132 may be a third party registry used in part to assign serial numbers to a collectible 114, recording 102, audiograph (104,120), videograph (108,122), or the like. In an embodiment, the third party may be a manufacturer, a distributor, or the like.

In an embodiment, the website registry 132 may be for a particular collectible 114, a plurality of collectibles 114, for a recording 102, or the like. The website registry 132 may be searchable and may have information that may include a digital audio provide, serial numbers, logo, symbol, seal, unique traceable identifier 130, or the like. In an embodiment, the website registry 132 may be available to any collector, may be password protected, may be controlled by an enterprise, may be controlled by an organization, may be organized by a club, or the like.

In an embodiment, distribute 128 may include the distribution of the collectible 114, distribution of the recording 102, distribution of the audiograph (104,120), distribution of the video graph (108,122), or the like. In an embodiment, the distribution 128 may be a web service, an enterprise, a store, at a collectibles 114 show, at a character or person 110 personal appearance, or the like. In an embodiment, the web service may be a media distribution server, associated with an Mp3, a cellular phone, a personal computer, or the like. In an embodiment, through the web service, a collector may request a recording 102, collectible 134 with an associated recording 102, or the like. The collector may be able to request a recording 102 from a particular character, person, celebrity, or other notable person 110 and may be able to request a personal recording from the character, person, celebrity, or other notable person 110.

While the invention has been described in connection with certain preferred embodiments, other embodiments would be understood by one of ordinary skill in the art and are encompassed herein.

1. A method, comprising:
receiving an audio recording from a celebrity and storing the audio recording in a digital format;
associating authentication information with the audio recording; and
communicating the audio recording to an intended recipient via an Internet service.

2. The method of claim 1, wherein the Internet service involves emailing the audio recording.

3. The method of claim 1, wherein the Internet service involves SMSing the audio recording.

4. The method of claim 1, wherein the Internet service involves communicating the audio recording through VoIP.

5. The method of claim 1, wherein the Internet service involves communicating the audio recording through a website interaction.

6. The method of claim 1, wherein the celebrity is a singer.

7. The method of claim 1, wherein the celebrity is an actor.

8. The method of claim 1, wherein the celebrity is a sports figure.

9. The method of claim 1, wherein the authentication information is stored in a tag.

10. The method of claim 1, wherein the authentication information includes digital rights management information to prevent the unauthorized copying of the audio recording.

11. The method of claim 1, wherein the step of receiving the audio recording involves receiving the audio recording through an Internet transmission.

12. The method of claim 11, wherein the Internet transmission involves emailing the audio recording.

13. The method of claim 11, wherein the Internet transmission involves text messaging the audio recording.

14. The method of claim 11, wherein the Internet transmission involves sending the audio recording through SMS.

15. The method of claim 11, wherein the Internet transmission involves posting the audio recording to a website.

16. The method of claim 1, wherein the audio recording includes a personalized message from the celebrity.

17. A system, comprising:
a receiving facility adapted to receive an audio recording from a celebrity and a storage facility adapted to store the audio recording in a digital format;
an association facility adapted to associate authentication information with the audio recording; and
a communication facility adapted to communicate the audio recording to an intended recipient via an Internet service.

18-20. (canceled)

21. The system of claim 17, wherein the Internet service involves communicating the audio recording through a website interaction.

22-25. (canceled)

26. The system of claim 17, wherein the authentication information includes digital rights management information to prevent the unauthorized copying of the audio recording.

27-31. (canceled)

32. The system of claim 17, wherein the audio recording includes a personalized message from the celebrity.
